(19) United States
(12) Patent Application Publication
(10) Pub. No.: US 2005/0286536 A1
(43) Pub. Date: Dec. 29, 2005

(54) Reducing backhaul bandwidth

(76) Inventors: Jeffrey Steinheider, Arlington, MA (US); Vanu Bose, Boston, MA (US); Victor Lum, Cambridge, MA (US)

Correspondence Address: FISH & RICHARDSON PC, P.O. BOX 1022, MINNEAPOLIS, MN, 55440-1022, US

(21) Appl. No.: 11/148,949

(22) Filed: Jun. 9, 2005

Related U.S. Application Data
(60) Provisional application No. 60/578,202, filed on Jun. 9, 2004.

(51) Int. Cl. H04L 12/28

(52) U.S. Cl. 370/395.52

(57) ABSTRACT

Methods and systems for reducing backhaul bandwidth are disclosed.

### PRIORITY TO OTHER APPLICATIONS

This application claims priority from and incorporates herein U.S. Provisional Application No. 60/578,202, filed Jun. 9, 2004, and titled “REDUCING BACKHAUL BANDWIDTH”.

### TECHNICAL FIELD

The following description relates to radio systems.

### BACKGROUND

In general, a cellular infrastructure includes tower sites and a central office. The tower sites include base stations and the central office includes a base station controller and the mobile switching center. The voice and data traffic is transported to and from the base stations via the T1 lines.

### SUMMARY

In some embodiments, the invention includes a method for reducing backhaul bandwidth using a software radio.

The method includes receiving at a base station an analog signal from a mobile unit, converting the analog signal to a digital signal, and performing software based processing on the digital signal. The method also includes determining a set of bits representing at least one of status and payload data and formatting the determined set of bits into a desired format for transmission to a central unit, e.g., a base station controller.

Embodiments can include one or more of the following.

The format can be an internet protocol (IP) based format. Performing software based processing can include performing signal demodulation. Performing software based processing can include performing error correction. Formatting determined set of bits into a desired format can include performing data compression. The received signal can be an EFR formatted signal and the desired format can be an AMR format.

In some embodiments, the invention includes a software based radio system configured to receive at a base station a communication from a mobile unit, the communication using an first coding technique, compress the communication using an second coding technique, and forward the communication to a central unit.

Embodiments can include one or more of the following.

The first coding technique can be an enhanced full rate (EFR) coding technique. The second coding technique can be an adaptive multi-rate (AMR) coding technique. The software based radio system can be further configured to determine if the communication comprises silence frames, and if the communication includes silence frames drop the communication. The software based radio system can be further configured to format the received communication. The software based radio system can be further configured to perform software based processing on the communication.

In some embodiments, the invention includes a method for reducing backhaul bandwidth using a software radio. The method includes receiving at a base station voice frames and silence frames from a mobile unit and determining if a particular frame of the received frames is a voice frame or a silence frame. If the particular frame is a silence frame, the method includes dropping the frame. If the particular frame is a voice frame, the method includes forwarding the particular frame to a central unit.

Embodiments can include one or more of the following. The method can also include receiving data frames and forwarding the data frames to the central unit.

In some embodiments, the invention includes a software based radio system configured to receive at a base station voice frames and silence frames from a mobile unit and determine if a particular frame of the received frames is a voice frame or a silence frame. If the particular frame is a silence frame, the system is further configured to drop the frame. If the particular frame is a voice frame, the system is further configured to forward the particular frame to a central unit.

Embodiments can include one or more of the following. The system can be further configured to receive data frames and forward the data frames to the central unit.

Advantages that can be seen in particular implementations include one or more of the following.

In some embodiments, the use of a software radio can reducing backhaul bandwidth and lower the operating expenses for wireless carriers today. Other features and advantages of the invention will become apparent from the following description, and from the claims.

In some embodiments, the software radio system is designed to employ packet based backhaul such that backhaul resources are used only when required to transmit information. For example, the system does not generate or transmit frames including only silence.

In some embodiments, the use of a software radio allows some of the vocoder function to be moved from the central office to the base station by running some of the software processes on the base station server instead of at the central office.

In some embodiments, the software radio system also includes the use of commercially available compression techniques, including those employed by GSM vocoders as well as IP compression tools. This can provide the advantage of reducing the amount of data transmitted across the network.

### BRIEF DESCRIPTION OF THE DRAWINGS

FIG. 1 is a block diagram of a cellular infrastructure deployment.

FIG. 2 is a block diagram of a mobile unit, a base station, and a central office.

FIG. 3 is a flow chart representing a method for reducing backhaul bandwidth.

FIG. 4 is a flow chart representing a method for reducing backhaul bandwidth.

FIG. 5 is a block diagram of a set of sites connected by a daisy chained T1 line.

### DETAILED DESCRIPTION

This disclosure combines new software radio capabilities with innovative new uses of existing software radio technology to create multiple methods for reducing backhaul bandwidth. Without wishing to be bound by theory, it is believed that when combined together, these methods can provide a greater than 50% reduction in required bandwidth, which translates to a greater than 50% reduction in the single largest operating expense line item for wireless carriers today.

Backhaul of voice and data from cell site to the core network is the single biggest operating expense for wireless carriers today. The majority of backhaul networks utilize dedicated T1 lines because they have guaranteed bandwidth and latency and are readily available, even in remote areas. While there are some other transport mechanisms for backhaul, including free space optical, unlicensed radio bands and even licensed spectrum, T1 lines will continue to haul the majority of traffic for some time due to the availability, standardization, compatibility with existing wireless equipment interfaces and already sunk costs on the part of wireless providers. Although described in the context of improving backhaul over T1 lines, the invention described here is not limited to use with T1 lines.

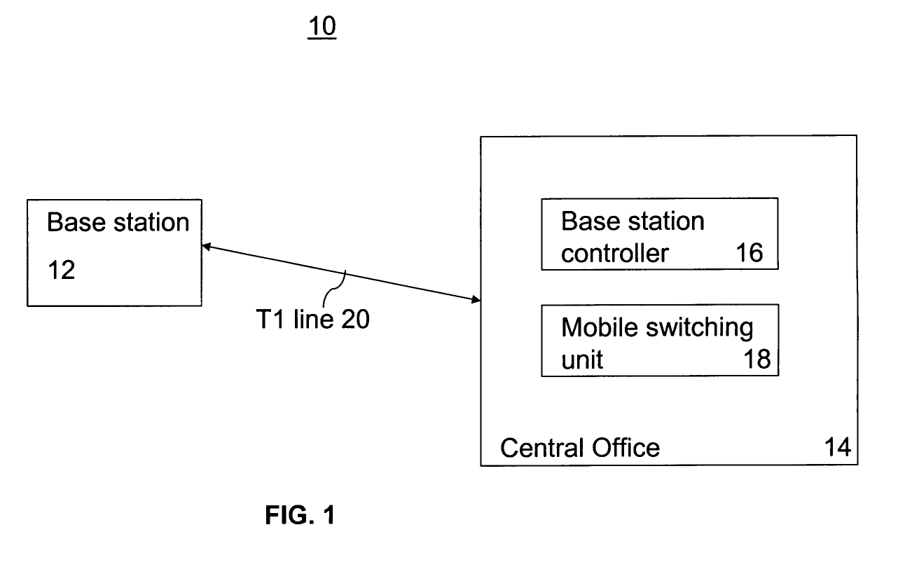

Referring to FIG. 1, a typical cellular infrastructure 10 deployment is shown. The tower sites 12 contain the base stations and the central office 14 contains the base station controller 16 and the mobile switching center 18. The voice and data traffic is transported to and from the base stations via the T1 lines 20. In conventional base stations, the time slots on the T1 are allocated to specific voice or data channels. While this static allocation is reasonable for constant rate voice traffic, often traffic is not as constant or predictable. The advent of variable rate voice coders and an increase in wireless data services introduces significant variability into the backhaul data stream, leading to significant inefficiencies due to the static allocation of T1 time slots. In addition, the static nature of the hardware radios used to build conventional base stations makes it difficult to move processing functions out into different points in the network in order to reduce backhaul bandwidth by trading computation for bandwidth at different nodes in the network.

While some providers have experimented with IP-based backhaul, the efficiencies have not lived up to expectations. This is due in part to the fact that the base station equipment is designed to use a traditional T1 interface, and cannot be easily modified to take full advantage of a packet-based backhaul network. As a result, some systems for backhaul compression are limited to accepting framed data from a time division multiplexed interface to the base station, stripping away frame headers and discarding frames that include only silence (e.g., pauses in conversation or periods when one party to the conversation is listening to the other and thus not generating information needful of transmission) then putting such remaining frames into packets comprising multiple frames for transmission over the backhaul medium.

By contrast, software radio base stations naturally interface with packet based systems. For example, the Vanu Software Radio base station runs an internet protocol (IP) stack under the Linux operating system and uses real time transport protocol (RTP) to transport voice traffic between the base station and base station controller. Because software radio systems are designed to employ packet based backhaul, backhaul resources are used only when required to transmit information. For example the software based radio system may not transmit silence packets. In addition, the software based radio system 10 can exploit commercially available compression techniques, including those employed by GSM vocoders as well as IP compression tools.

The software based radio system 10 enables the use of a number of techniques to reduce backhaul bandwidth, and the potential for combining one or more of these techniques together for increased advantages and/or savings.

There are multiple types of voice encoder (vocoders) used in wireless networks today. In a global system for mobile communication (GSM) the full-rate, half-rate, enhanced full-rate (EFR) and adaptive multi-rate vocoders (AMR) are all written into the standard. The choice of vocoder is a tradeoff between voice quality, RF link quality, and RF bandwidth. Each vocoder has different bandwidth requirements. Voice quality is the overwhelming parameter in the choice of vocoder. In particular, for poor quality RF links it is important to have a higher quality voice coder at the cost of higher bandwidth.

In a typical network deployment the vocoder is found in a hardware component known as a TRAU, which resides at the central office. Thus, in a traditional system, the vocoder used over the air interface is also used over the backhaul. Thus, when link quality between the mobile and the base station is poor, a vocoder that requires higher bandwidth is employed and higher bandwidth is occupied all the way to the TRAU. However, on the backhaul, link quality is essentially not an issue, and a higher rate of compression could be utilized. The flexibility of software radio allows us to move some of the vocoder function from the TRAU at the central office out to the base station, by simply running some of the software processes on the base station server instead of at the central office.

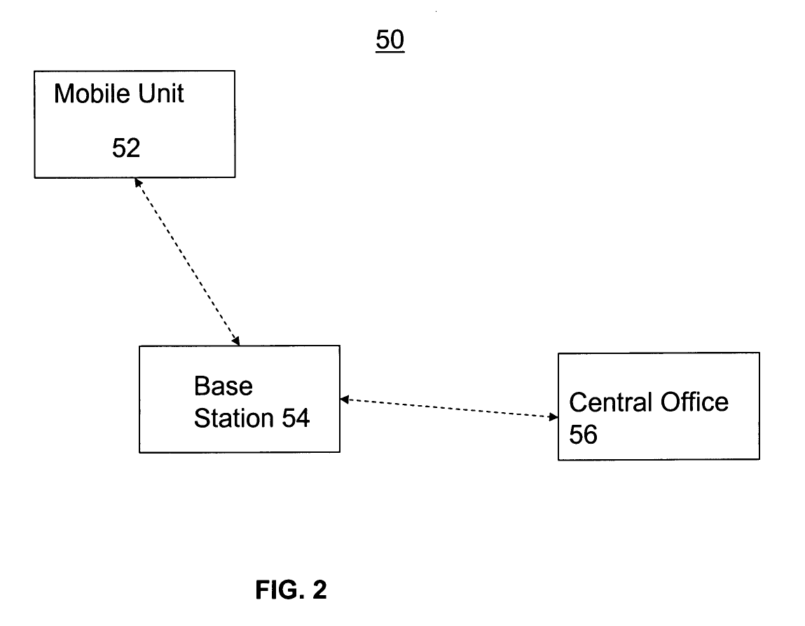

Referring to FIG. 2, a system 50 including a mobile unit 52, a base station 54, and a central office 56 is shown. System 10 moves at least a portion of the vocoder functionality from the central office 56 to the base station 54. For example, if channel conditions are such that the EFR is used for a particular mobile 52, the base station 54 could communicate with the mobile 52 using EFR then compress the signal using low rate AMR to communicate with the central office 56. This compression results in bandwidth savings in contrast to a traditional deployment. Without wishing to be bound by theory, it is believed that the potential bandwidth savings is up to 50%, as the full rate vocoder (e.g., used for communication between the mobile unit 52 and the base station 54) uses twice the bandwidth of the lowest encoding rate for the AMR vocoder (e.g., used for communication between the base station 52 and the central office 56).

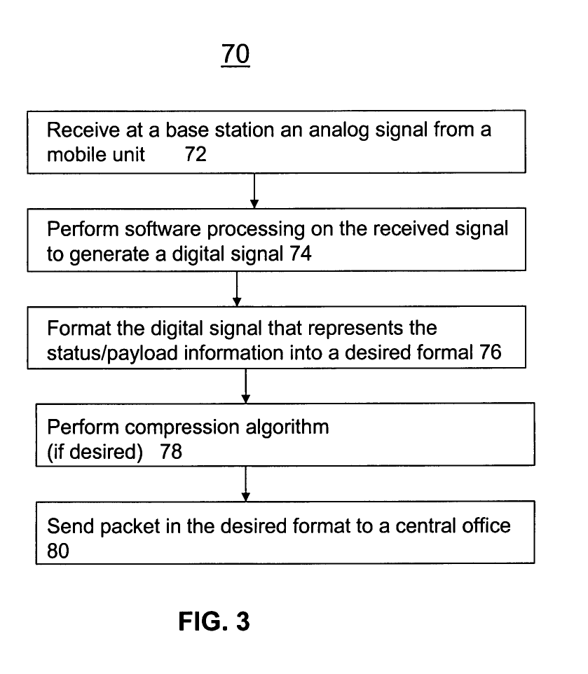

Referring to FIG. 3, a communication process 70 for reducing backhaul bandwidth is shown. In general, a mobile unit transmits a signal and the base station receives 72 the signal from the mobile unit. After receiving the signal from the mobile unit, the base station performs 74 software based processing on the received signal to generate a digital signal. Examples of software based processing in addition to analog to digital conversion include signal demodulation and error correction. The base station formats 76 the digital signal that represents the status and payload portion of the received signal into a desired format. For example, the base station may generate an IP formatted packet. If desired, the base station can further process the packet by performing 78 a compression algorithm on the packet. Subsequently, the base station sends 80 the generated packet to a central office.

DTX, discontinuous transmission, is a GSM mode designed to conserve battery life of the mobile terminal. Under normal operation, when the user is not speaking, the phone still transmits voice frames containing silence. With DTX, these silence frames are compressed, reducing the total amount of transmitted data from the phone. For example, in some cases DTX can reduce the amount of transmitted data by more than 50%. Conventional base stations reconstitute the silence frames and send them over the backhaul network to the Transcoder/Rate Adapter Unit (TRAU) at the central office. This approach keeps the data stream consistent with what the TRAU is expecting to receive from the base station. Again, leveraging the flexibility of software to move processing components to different points in the network and modify the processing, we can change the TRAU software to accept data streams with silence frames suppressed and, if necessary, to reconstitute them at the TRAU. This will result in reduced bandwidth throughout the system, from the mobile all the way back to the TRAU. Similarly, the DTX mode can be enabled on the transmit path, resulting in the same bandwidth savings for both the forward and reverse paths.

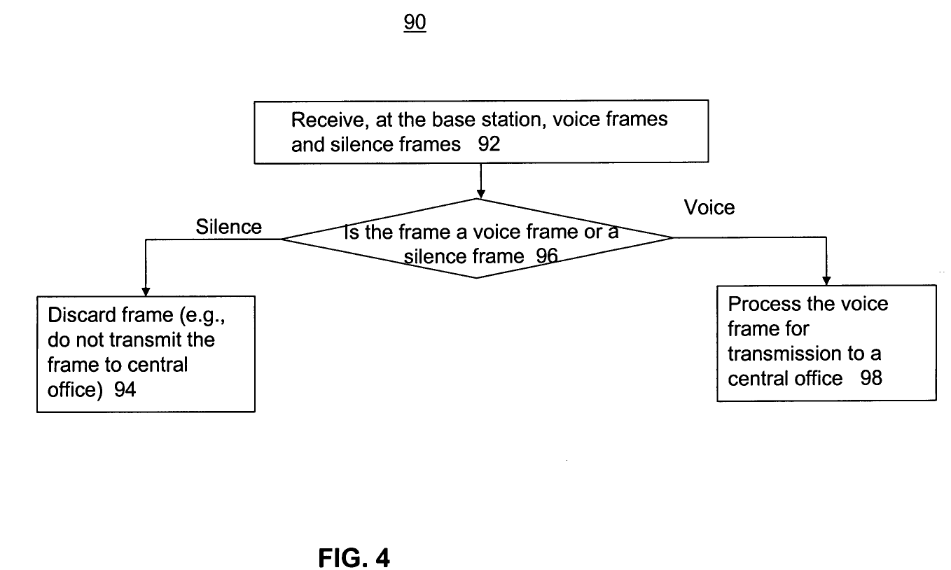

Referring to FIG. 4, a process 90 for reducing bandwidth is shown. A base station receives 92 a communication from a mobile unit. The communication can include both voice frames and silence frames. The base station determines 96 if a particular communication is a voice frame or silence frame. If the communication is a silence frame, the base station discards the frame (i.e., does not transmit the silence frame to the central office). If the communication is a voice frame, the base station processes 98 the communication and transmits the communication to the central office. Process 90 reduces the backhaul bandwidth by transmitting only frames that include useful information.

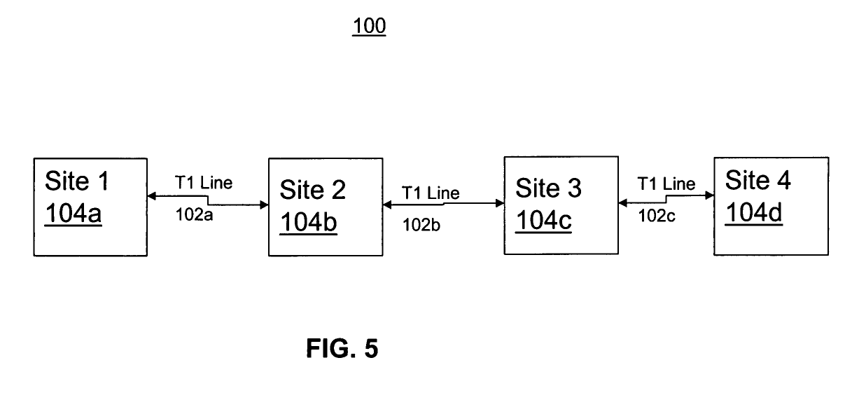

In rural areas, where the call volume is low, a strategy of daisy chaining T1's between sites is used to reduce cost. As shown in FIG. 5, in this type of deployment, a single T1 line (e.g., line 102a-102c) is routed to multiple sites (e.g., sites 104a-104d), and specific time slots on the T1 are statically assigned to each site. Again, this is because of the design of traditional base station equipment that expects a dedicated bit rate channel, rather than a variable packet-based channel.

Leveraging packet-based backhaul and combining it with daisy chaining of T1's can allow the dynamic sharing of bandwidth between sites. With this approach, if a given cell has a large number of calls, they can be supported by “borrowing” backhaul bandwidth from other sites on the same daisy chain that are lightly loaded during the same period. The cost savings can be calculated by comparing the cost of statically allocating the same bandwidth and comparing the increase in revenue due to the ability to handle higher peak call volumes at a given site.

Due to the customer expectations for voice quality and the streaming nature of voice, it is important to have dedicated bandwidth for each voice call. The bandwidth requirements and expectations for data are quite different. Due to the static allocation of today's backhaul networks, data channels get statically allocated bandwidth whether or not the data channel is being fully utilized. The mix of voice and data suggests that a QoS admission control policy that ensures each voice call has enough bandwidth, but allows the available bandwidth to be used for data when voice calls are not present. In addition, feedback mechanisms from the network could be used by the base station controller to decide if additional calls can be supported given current network demands.

Unlike traditional systems, which require additional hardware to implement many of these approaches, the techniques described herein suggest software changes to existing software radio systems.

There has been described novel apparatus and techniques for reducing backhaul bandwidth. It is evident that those skilled in the art may now make numerous modifications and uses of and departures from specific apparatus and techniques herein disclosed without departing from the inventive concepts. Consequently, the invention is to be construed as embracing each and every novel feature and novel combination of features present in or possessed by the apparatus and techniques herein disclosed and limited solely by the spirit and scope of the appended claims.

Other implementations are within the scope of the following claims:

1. A method for reducing backhaul bandwidth using a software radio, the method comprising:
receiving at a base station an analog signal from a mobile unit;
converting the analog signal to a digital signal;
performing software based processing on the digital signal;
determining a set of bits representing at least one of status and payload data;
formatting the determined set of bits into a desired format for transmission to a central unit.

2. The method of claim 1, wherein the desired format is an internet protocol (IP) based format.

3. The method of claim 1, wherein performing software based processing includes performing signal demodulation.

4. The method of claim 1, wherein performing software based processing includes performing error correction.

5. The method of claim 1, wherein formatting determined set of bits into a desired format includes performing data compression.

6. The method of claim 1, wherein:
the received signal is an EFR formatted signal; and
the desired format is an AMR format.

7. The method of claim 1, further comprising determining if the communication comprises silence frames, and if the communication comprises silence frames drop the communication.

8. A software based radio system configured to:
receive at a base station a communication from a mobile unit, the communication using a first coding technique;
compress the communication using a second coding technique; and
forward the communication to a central unit.

9. The software based radio system of claim 8, wherein the first coding technique comprises an enhanced full rate (EFR) coding technique.

10. The software based radio system of claim 8, wherein the second coding technique comprises an adaptive multi-rate (AMR) coding technique.

11. The software based radio system of claim 8, wherein the software based radio system is further configured to determine if the communication comprises silence frames, and if the communication comprises silence frames drop the communication.

12. The software based radio system of claim 8, wherein the software based radio system is further configured to format the received communication.

13. The software based radio system of claim 8, wherein the software based radio system is further configured to perform software based processing on the communication.

14. A method for reducing backhaul bandwidth using a software radio, the method comprising:
receiving at a base station voice frames and silence frames from a mobile unit;
determining if a particular frame of the received frames is a voice frame or a silence frame;
if the particular frame is a silence frame, dropping the frame; and
if the particular frame is a voice frame forwarding the particular frame to a central unit.

15. The method of claim 14, further comprising receiving data frames and forwarding the data frames to the central unit.

16. A software based radio system configured to:
receive at a base station voice frames and silence frames from a mobile unit;
determine if a particular frame of the received frames is a voice frame or a silence frame;
if the particular frame is a silence frame, drop the frame; and
if the particular frame is a voice frame forward the particular frame to a central unit.

17. The software based radio system of claim 16, further configured to receive data frames and forward the data frames to the central unit.
